(19) United States
(12) Patent Application Publication
(10) Pub. No.: US 2011/0054993 A1
(43) Pub. Date: Mar. 3, 2011

(54) ELECTRONIC COUPON MANAGEMENT, DISTRIBUTION, AND RESERVATION SYSTEMS AND METHODS

(75) Inventors: Stephanie Bauer Marshall, Alexandria, VA (US); John Mark Allen, Oak Hill, VA (US)

(73) Assignee: VERIZON PATENT AND LICENSING, INC., Basking Ridge, NJ (US)

(21) Appl. No.: 12/549,022

(22) Filed: Aug. 27, 2009

(51) Int. Cl. G06Q 30/00; G06F 15/16

(52) U.S. Cl. 705/14.35; 709/206

(57) ABSTRACT

Exemplary electronic coupon management, distribution, and reservation systems and methods are disclosed. An exemplary method includes an electronic coupon subsystem maintaining data representative of an electronic coupon in a repository of coupon data such that the electronic coupon is accessible to a plurality of access devices associated with a plurality of consumers, receiving a request to reserve the electronic coupon from an access device within the plurality of access devices, the access device associated with a consumer within the plurality of consumers, and reserving the electronic coupon for the consumer for a reservation time period such that the electronic coupon is unavailable to one or more other consumers within the plurality of consumers during the reservation time period. Corresponding systems and methods are also disclosed.

### BACKGROUND INFORMATION

A strategy commonly used to market products or services is to issue coupons offering discount prices for the products or services. Traditionally, coupons are printed and distributed through channels such as newspapers, direct mail, or other print media. Electronic coupons are also distributed through electronic channels such as electronic mail and the Internet.

However, traditional distribution channels for coupons are inefficient, fragmented, and in decline. For example, typically only a very small percentage of the coupons distributed through traditional channels are actually redeemed. This inefficiency may be due at least in part to the traditional and fragmented process consumers must perform to redeem coupons. In particular, in fragmented steps, consumers must clip or print, store, recall, tote, and redeem coupons distributed through traditional channels. Moreover, traditional coupon distribution channels typically require long lead times to implement and provide little or no control over redemption to marketers after launch of coupon marketing campaigns. Such a lack of control may expose marketers to significant risks associated with unforeseen consumer responses (e.g., unforeseen high rates of redemption).

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary electronic coupon management, distribution, and reservation system.

FIG. 2 illustrates an exemplary implementation of the system of FIG. 1.

FIG. 3 illustrates another exemplary implementation of the system of FIG. 1.

FIG. 4 illustrates an exemplary electronic coupon management, distribution, and reservation device.

FIG. 5 illustrates an exemplary electronic coupon management and distribution method.

FIG. 6 illustrates an exemplary graphical user interface.

FIG. 7 illustrates an exemplary graphical user interface displayed by an access device.

FIG. 8 illustrates an exemplary graphical user interface displayed by an access device.

FIG. 9 illustrates an exemplary graphical user interface displayed by an access device.

FIG. 10 illustrates an exemplary electronic coupon reservation method.

FIG. 11 illustrates an exemplary graphical user interface displayed by an access device.

FIG. 12 illustrates an exemplary graphical user interface displayed by an access device.

FIG. 13 illustrates an exemplary electronic coupon reservation method.

FIG. 14 illustrates an exemplary graphical user interface displayed by an access device.

FIG. 15 illustrates an exemplary electronic coupon reservation method.

FIG. 16 illustrates an exemplary electronic coupon reservation method.

FIG. 17 illustrates an exemplary graphical user interface displayed by an access device.

FIG. 18 illustrates an exemplary graphical user interface displayed by an access device.

### DETAILED DESCRIPTION OF PREFERRED EMBODIMENTS

Exemplary electronic coupon management, distribution, and reservation systems and methods are described herein. The exemplary systems and methods may provide improved control of advertising campaigns, improved rates of return for marketers, improved targeting of advertisements, increased value for consumers, improved convenience in discovering, accessing, and redeeming coupons, and/or economies of scale.

As used herein, the term “coupon” may refer generally to any offer, discount, deal, or promotion associated with a product or service. Typically, a coupon provides a discount of some sort to a consumer who uses the coupon in association with a purchase of a product or service. The term “electronic coupon” as used herein may refer to electronic data representative of a coupon.

As used herein, the term “consumer” may refer generally to any individual or organization that purchases or may potentially purchase or otherwise consume products and/or services. The term “marketer” as used herein may refer generally to any individual or organization that sells, markets, advertises, manufactures, distributes, or otherwise provides or promotes products and/or services for consumption and/or for further distribution.

Exemplary embodiments of electronic coupon management, distribution, and reservation systems and methods will now be described in more detail with reference to the accompanying drawings.

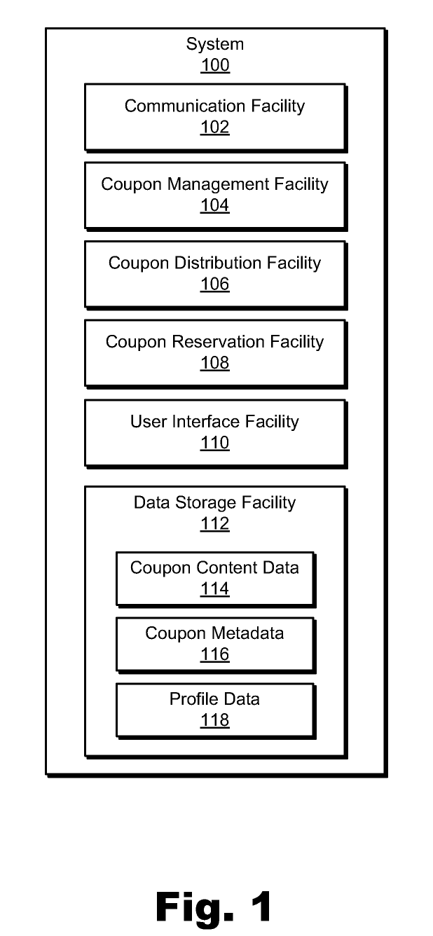

FIG. 1 illustrates an exemplary electronic coupon management, distribution, and reservation system 100 (or simply “system 100”). While an exemplary system 100 is shown in FIG. 1, the components and configuration of system 100 illustrated in FIG. 1 are not intended to be limiting. Additional or alternative components and/or configurations may be used in other embodiments. In certain alternative embodiments, for example, one or more of the components shown in FIG. 1 may be omitted or combined.

System 100 may include, but is not limited to, a communication facility 102, a coupon management facility 104, a coupon distribution facility 106, a coupon reservation facility 108, a user interface facility 110, and a data storage facility 112 selectively and communicatively coupled one to another. Any suitable communication technologies, including any of the communication technologies mentioned herein, may be employed to facilitate communications between facilities 102-112.

Communication facility 102 may be configured to communicate with one or more computing devices. In particular, communication facility 102 may be configured to transmit and/or receive communication signals and/or data to/from a user access device and/or a coupon data source device. Examples of communication facility 102 include, without limitation, a wired network interface (such as a network interface card), a wireless network interface (such as a wireless network interface card), a modem, an optical fiber network terminal, and any other suitable interface.

Coupon management facility 104 may be configured to receive, store, aggregate, organize, maintain, and otherwise manage coupon data. Coupon data may include any data representative of one or more electronic coupons. The coupon data may be stored in a repository of coupon data within data storage facility 112 as coupon content data 114 and coupon metadata 116. As described in more detail further below, in some examples, coupon management facility 104 may be configured to receive data representative of coupon data from one or more sources of electronic coupons, such as marketers and/or access devices associated with marketers, and aggregate and store the received coupon data in a repository of coupon data within data storage facility 112.

As described in more detail further below, coupon management facility 104 may provide one or more tools configured to allow and/or assist a marketer in setting up a marketing campaign, including setting one or more controls and/or parameters of a marketing campaign and/or electronic coupons. For example, a marketer may be able to specify a number of available electronic coupons, a timeframe within which electronic coupons are available and/or valid (e.g., an expiration setting), and a timeframe for which electronic coupons may be reserved by consumers. Other tools may be provided that allow and/or assist a marketer in configuring a marketing campaign and/or electronic coupons to be targeted to a particular demographic of consumers. Additional tools may be provided that allow and/or assist a marketer in configuring a strategy for distributing electronic coupons. For example, a marketer may be able to set a parameter to indicate whether a particular electronic coupon may be distributed as an alternative to another electronic coupon for a similar product or service. For instance, when a consumer searches for or selects an electronic coupon for Pampers brand diapers, another electronic coupon for Huggies brand diapers is distributed for access by the consumer.

Coupon distribution facility 106 may be configured to distribute electronic coupons maintained in data storage facility 112 to one or more consumers and/or access devices associated with consumers. For example, coupon distribution facility 106 may receive a request for an electronic coupon from an access device and may transmit data representative of the electronic coupon to the access device in response to the request. In addition, coupon distribution facility 106 may be configured to facilitate access to electronic coupons maintained in data storage facility 112, such as by providing search, browsing, and/or other discovery tools for utilization by a user to discover and access one or more electronic coupons. For example, coupon distribution facility 106 may be configured to search coupon metadata 116 to identify one or more particular electronic coupons based on user-provided search terms.

Coupon distribution facility 106 may be further configured to perform one or more operations related to redemption and/or expiration of electronic coupons. For example, when an electronic coupon is redeemed, coupon distribution facility 106 may record and report the redemption (e.g., to a source of the coupon such as a marketer and/or an access device associated with a marketer). When an electronic coupon expires based on an expiration date associated with the electronic coupon, coupon distribution facility 106 may perform one or more operations to expire the electronic coupon, such as by making the electronic coupon unavailable to consumers and/or deleting data representative of the electronic coupon from data storage facility 112.

Coupon reservation facility 108 may be configured to reserve electronic coupons maintained in data storage facility 112, renew reservations of electronic coupons, and release reservations of electronic coupons. To this end, coupon reservation facility 108 may provide one or more tools (e.g., user interface tools) configured to facilitate reservation of an electronic coupon. Hence, coupon reservation facility 108 may receive a request to reserve an electronic coupon. The request may be received from a consumer and/or an access device associated with the consumer. If the requested electronic coupon is available for reservation, coupon reservation facility 108 may reserve the electronic coupon for the consumer for a reservation time period such that the reserved electronic coupon is unavailable to other consumers during the reservation time period.

Coupon reservation facility 108 may track reservations of electronic coupons and perform one or more predefined actions in response to one or more predetermined tracking events. For instance, when a reservation time period associated with a reservation of an electronic coupon expires or is about to expire, coupon reservation facility 108 may automatically perform one or more predefined actions. As an example, coupon reservation facility 108 may release a reservation of an electronic coupon when the reservation time period associated with the reservation expires. As another example, coupon reservation facility 108 may detect an upcoming expiration of a reservation of an electronic coupon and notify a consumer for whom the electronic coupon is reserved of the upcoming expiration (e.g., by transmitting a notification message to an access device associated with the consumer). In some examples, the consumer may respond by indicating a desire to renew the reservation. Coupon reservation facility 108 may receive a request to renew the reservation and renew the reservation such as by extending the reservation time period.

In certain embodiments, coupon reservation facility 108 may be configured to swap reservations of electronic coupons between users. For example, while an electronic coupon is reserved for a consumer, a swap request for the electronic coupon may be received by coupon reservation facility 108 from another consumer. The swap request may indicate a desire to swap for the reservation of the electronic coupon. In some examples, the swap request may indicate one or more swap proposals, such as one or more electronic coupons reserved for the other consumer (or other consideration) that the other consumer is willing to offer in exchange for the electronic coupon reserved for the consumer. Coupon reservation facility 108 may notify the consumer of the swap request, such as by transmitting a notification of the swap request to an access device associated with the consumer. If the consumer agrees to the swap request, coupon reservation facility 108 may receive a message indicating an agreement to the swap request from the consumer (e.g., from an access device associated with the consumer) and, in response to the agreement, swap one or more reservations of electronic coupons between the consumers. For example, the reservation of the electronic coupon may be switched from the consumer to the other consumer in response to the agreement to the swap request.

System 100 may be configured to maintain data representative of a status for each electronic coupon maintained in data storage facility 112. In certain embodiments, the status may be used to determine whether an electronic coupon is available, reserved, redeemed, or expired. To this end, in certain embodiments, possible statuses of an electronic coupon may include “available,” “reserved,” “redeemed,” and “expired.” One or more of the facilities 102-112 of system 100 may be configured to access and/or update a status of an electronic coupon. For example, when an electronic coupon is initially stored in data storage facility 112, the status of the electronic coupon may be marked as “available,” meaning that the electronic coupon is available to be accessed by one or more consumers and/or access devices. When the electronic coupon is reserved for a consumer, the status of the electronic coupon may be marked as “reserved” to indicate that the electronic coupon is currently reserved to a consumer and unavailable to one or more other consumers. When the reservation of the electronic coupon is released, the status of the electronic coupon may be marked as “available,” meaning that the electronic coupon is once again available to be accessed by one or more consumers and/or access devices. When an electronic coupon is redeemed, the status of the electronic coupon may be marked as “redeemed” to indicate that the electronic coupon has been redeemed and is no longer available to consumers. When an electronic coupon is expired (e.g., based on an expiration date of the coupon), the status of the electronic coupon may be marked as “expired” to indicate that the electronic coupon is expired and no longer valid.

User interface facility 110 may be configured to provide one or more user interfaces configured to facilitate user interaction with system 100. For example, user interface facility 110 may provide a user interface through which one or more functions, options, features, and/or tools may be provided to a user and through which user input may be received. In certain embodiments, user interface facility 110 may be configured to provide one or more coupon management tools in one or more user interfaces for use by a marketer and one or more electronic coupon access, reservation, renewal, and redemption tools in one or more user interfaces for use by a consumer. Exemplary graphical user interfaces that may be provided by user interface facility 110 are described in detail further below.

Data storage facility 112 may be configured to maintain coupon content data 114, coupon metadata 116, profile data 118, and any other data as may serve a particular application. As mentioned, coupon content data 114 may include data (e.g., graphical images, text, etc.) representative of one or more electronic coupons maintained within a repository of electronic coupons. Coupon metadata 116 may include any data descriptive of or otherwise associated with coupon content data 114. For example, coupon metadata 116 may include coupon identifiers, coupon descriptors, retailer identifiers (e.g., store names), retailer type identifiers (e.g., store types such as “grocer” and “restaurants”), coupon category identifiers (e.g., “grocery” and “dining out”), product and/or service brand identifiers, manufacturer identifiers, coupon source identifiers, reservation settings (e.g., reservation time periods), expiration settings (e.g., marketing campaign and/or coupon expiration dates), coupon status identifiers, and any other information descriptive of and/or useful for identifying electronic coupons. Profile data 118 may include any data associated with profiles and/or preferences of users (e.g., consumers and/or marketers) accessing system 100. As described further below, profile data 118 may be utilized to selectively provide one or more user interfaces and/or coupon tools to users based on the profile data 118. Profile data 118 may be further utilized in conjunction with accessing, reserving, renewing, distributing, managing, and redeeming electronic coupons. For example, an electronic coupon may be reserved for a user by associating the reservation with the user's profile stored in profile data 118.

System 100, including facilities 102-112, may include any computer hardware and/or computer-implemented instructions (e.g., software), or combinations of computer-implemented instructions and hardware, configured to perform one or more of the processes described herein. In particular, system 100 may be implemented on one physical computing device or may be implemented on more than one physical computing device. Accordingly, system 100 may include any number of computing devices, and may employ any of a number of computer operating systems.

One or more of the processes described herein may be implemented at least in part as instructions executable by one or more computing devices. In general, a processor (e.g., a microprocessor) receives instructions, from a computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media and/or volatile media. Common forms of computer-readable media include, for example, a floppy disk, flexible disk, hard disk, magnetic tape, any other magnetic medium, a CD-ROM, DVD, any other optical medium, a RAM, a DRAM a PROM, an EPROM, a FLASH-EEPROM, any other memory chip or cartridge, or any other medium from which a computer can read.

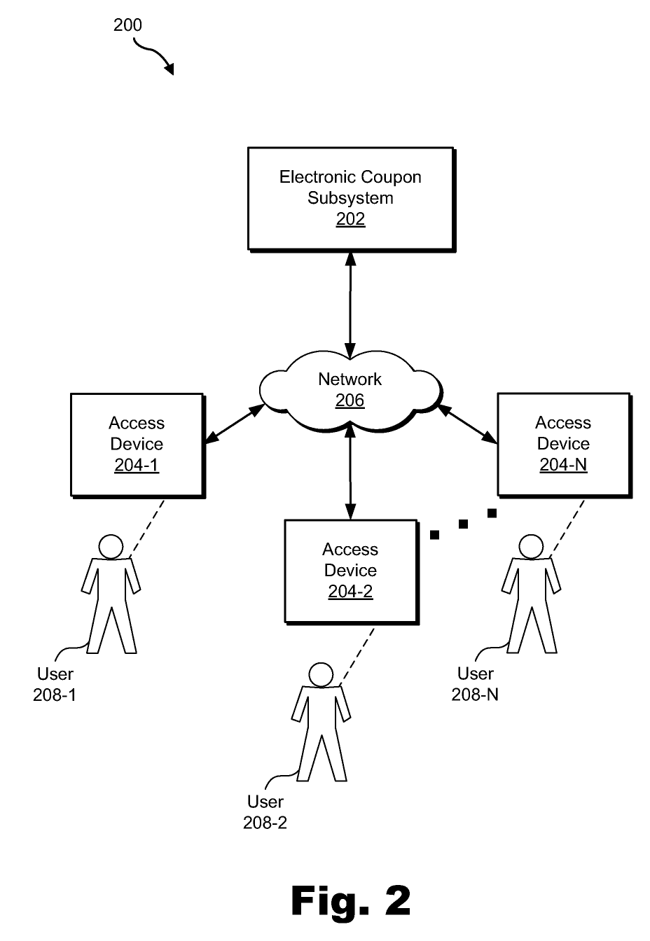

FIG. 2 illustrates an exemplary implementation 200 of system 100. As shown in FIG. 2, implementation 200 may include an electronic coupon subsystem 202 (or simply “coupon subsystem 202”) selectively and communicatively connected to a plurality of access devices 204 (e.g., access devices 204-1 through 204-N).

Access devices 204 and coupon subsystem 202 may communicate using any communication platforms and technologies suitable for transporting data and/or communication signals, including known communication technologies, devices, media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies, in-band and out-of-band signaling technologies, and other suitable communications networks and technologies.

Access devices 204 and coupon subsystem 202 may communicate via a network 206, which may include one or more networks, including, but not limited to, wireless networks (Wi-Fi networks), (e.g., wireless communication networks), mobile telephone networks (e.g., cellular telephone networks), closed media networks, open media networks, closed communication networks, open communication networks, satellite networks, navigation networks, broadband networks, narrowband networks, voice communication networks (e.g., VoIP networks), the Internet, and any other networks capable of carrying data and/or communications signals between access devices 204 and coupon subsystem 202. Communications between coupon subsystem 202 and access devices 204 may be transported using any one of above-listed networks, or any combination or sub-combination of the above-listed networks. In certain exemplary embodiments, network 206 includes a mobile telephone network.

Access devices 204 may be associated with a plurality of users 208 (e.g., users 208-1 through 208-N), which in certain embodiments may be subscribers to or users of one or more services (e.g., a wireless telephone service, a coupon distribution service, and/or a shopping list service) provided over network 206. Where the subscription service is provided to a significant number of subscribers such as subscribers to a mobile phone service, economies of scale may contribute to the effectiveness of implementation 200. A user 208 may include a consumer or a marketer. Coupon subsystem 202 may maintain user profiles for users of access devices 204 and utilize the user profiles to provide coupon management, distribution, and reservation services and/or data, as described herein.

An access device 204 may include any device configured to perform one or more of the access device operations described herein, including communicating with coupon subsystem 202 by way of network 206. Access device 204 may include, but is not limited to, a wireless computing device, a personal computer, a wireless communication device (e.g., a mobile telephone configured to access one or more services provided over network 206), a portable computing device (e.g., a laptop computer), a portable communication device, a personal digital assistant, a vehicular computing and/or communication device, a vehicle (e.g., an automobile), a portable navigation device, a Global Positioning System (“GPS”) device, a personal media player device, and/or any other access device configured to perform one or more of the access device operations described herein.

Coupon subsystem 202 may include one or more computing devices (e.g., one or more server devices) implementing one or more components of system 100. In certain embodiments, system 100 may be implemented entirely by or within coupon subsystem 202. In other embodiments, components of system 100 may be distributed across coupon subsystem 202 and access devices 204. For example, an access device 204 may include a client (e.g., a client application) implementing one or more components (e.g., user interface facility 110) of system 100.

In certain embodiments, one or more components of system 100 may be integrated or interfaced with one or more applications and/or services, such as a consumer shopping list application and/or a recipe application. For example, one or more components of system 100 may integrated or interfaced with a shopping list application and/or a recipe application running on an access device 204.

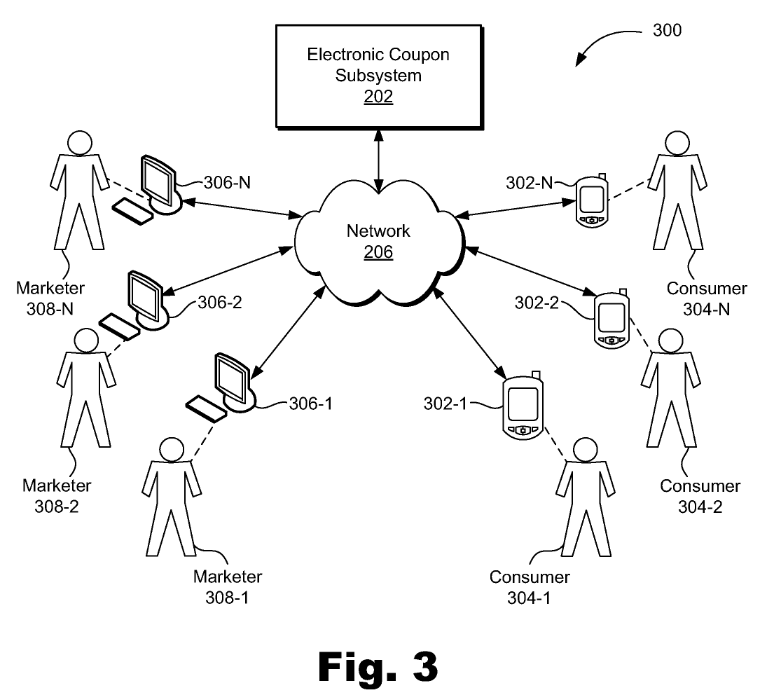

FIG. 3 illustrates another exemplary implementation 300 of system 100. As shown in FIG. 3, implementation 300 may include coupon subsystem 202 in communication with a plurality of access devices 302 (e.g., access devices 302-1 through 302-N) in the form of mobile devices, such as mobile phones, associated with a plurality of consumers 304 (e.g., consumers 304-1 through 304-N) and with a plurality of access devices 306 (e.g., access devices 306-1 through 306-N) in the form of personal computers associated with a plurality of marketers 308 (e.g., marketers 308-1 through 308-N).

In implementation 300, marketers 308 may utilize access devices 306 to provide (e.g., upload) data representative of electronic coupons to coupon subsystem 202, which may store, aggregate, organize, and maintain data representative of the electronic coupons in a repository of coupon data as described above. Marketers 308 may also utilize access devices 306 to manage electronic coupons maintained in coupon subsystem 202. For example, a marketer 308 may modify settings and/or other data associated with electronic coupons such as by changing an expiration date or reservation time period of an electronic coupon.

Consumers 304 may utilize access devices 302 to access, reserve, renew, and redeem electronic coupons maintained in coupon subsystem 202. Where access devices 302 comprise mobile devices such as mobile phones, many consumers 304 typically carry their access devices 302 wherever they go. For example, many consumers 304 keep their access devices 302 with them while shopping. An access device 302 being carried by a consumer 304 who is shopping may provide improved conveniences and/or efficiencies for accessing, reserving, and redeeming electronic coupons. In such mobile implementations, electronic coupons may be referred to as “mobile coupons,” which are accessible and/or redeemable via a mobile device. Examples of graphical user interfaces (“GUIs”) that may be displayed to a consumer and configured to facilitate accessing, reserving, renewing, and redeeming of electronic coupons are described further below.

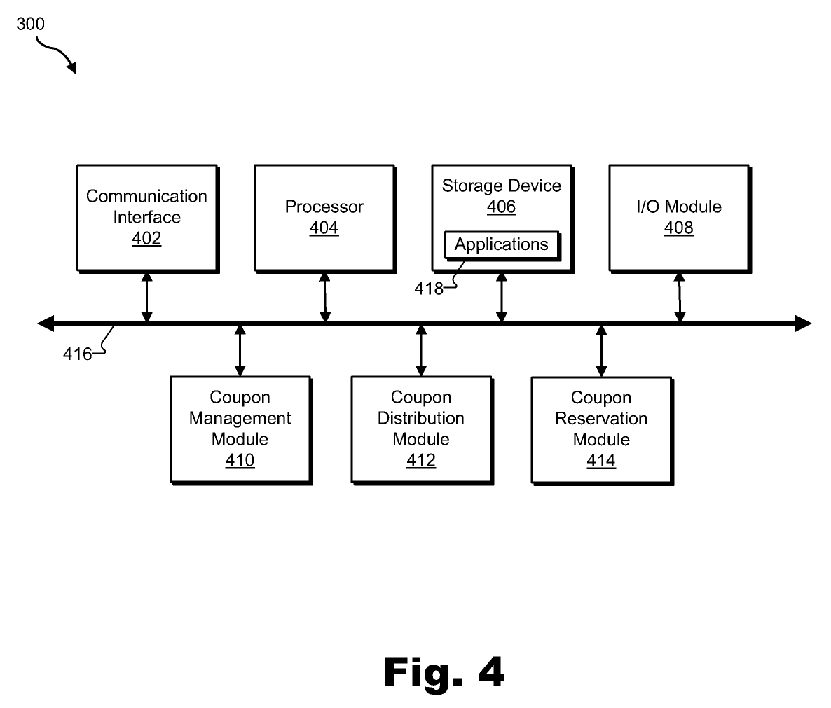

FIG. 4 illustrates an exemplary electronic coupon processing device 400 (or simply “device 400”). One or more components of system 100 may be implemented by or on device 400. Additionally or alternatively, electronic coupon subsystem 202 and/or access device 204, 302, or 306 may include or be implemented by device 400. As shown in FIG. 4, device 400 may include a communication interface 402, a processor 404, a storage device 406, an input/output (“I/O”) module 408, a coupon management module 410, a coupon distribution module 412, and a coupon reservation module 414 communicatively coupled one to another via a communication infrastructure 416. The components of device 400 may communicate with one another, including sending data to and receiving data from one another, using any suitable communication technologies. Moreover, the components of device 400 may be implemented on any computing device or combination of computing devices configured to process electronic coupons, such as any of the computing devices disclosed herein.

While an exemplary device 400 is shown in FIG. 4, the components illustrated in FIG. 4 are not intended to be limiting. Additional or alternative components may be used in other embodiments. Components of the device 400 shown in FIG. 4 will now be described in additional detail.

Communication interface 402 may be configured to communicate with one or more computing devices. In particular, communication interface 402 may be configured to transmit and/or receive communication signals and/or data to/from an access device and/or an electronic coupon source device. Examples of communication interface 402 include, without limitation, a wired network interface (such as a network interface card), a wireless network interface (such as a wireless network interface card), a modem, an optical fiber network terminal, and any other suitable interface.

Processor 404 generally represents any type or form of processing unit capable of processing data or interpreting, executing, and/or directing execution of one or more of the instructions, processes, and/or operations described herein. Processor 404 may direct execution of operations in accordance with one or more applications 418 or other computer-executable instructions such as may be stored in storage device 406 or another computer-readable medium.

Storage device 406 may include one or more data storage media, devices, or configurations and may employ any type, form, and combination of data storage media and/or device. For example, storage device 406 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 406. For example, data representative of one or more executable applications 418 configured to direct processor 404 to perform any of the operations described herein may be stored within storage device 406. In some examples, data may be arranged in one or more databases residing within storage device 406.

I/O module 408 may be configured to receive user input and provide user output and may include any hardware, firmware, software, or combination thereof supportive of input and output capabilities. For example, I/O module 408 may include one or more devices for capturing user input, including, but not limited to, a microphone, a keyboard or keypad, a touch screen component (e.g., touch screen display), a data receiver (e.g., an RF or infrared receiver), and/or one or more input buttons.

I/O module 408 may include one or more devices for presenting output to a user, including, but not limited to, a graphics engine, a display (e.g., a display screen, one or more output drivers (e.g., display drivers), one or more audio speakers, one or more audio drivers, and a data transmitter. In certain embodiments, I/O module 408 is configured to provide (e.g., transmit) graphical data to a display and/or user access device for presentation to a user. The graphical data may be representative of one or more GUIs, GUI views, coupon content views, and/or any other view as may serve a particular implementation.

Coupon management module 410 may be configured to perform and/or initiate performance of any of the operations of coupon management facility 104 described herein. Coupon distribution module 412 may be configured to perform and/or initiate performance of any of the operations of coupon distribution facility 106 described herein. Coupon reservation module 414 may be configured to perform and/or initiate performance of any of the operations of coupon reservation facility 108 described herein.

In some examples, communication facility 102, coupon management facility 104, coupon distribution facility 106, coupon reservation facility 108, user interface facility 110, and data storage facility 112 of system 100 shown in FIG. 1 may be implemented by or within one or more components of device 400. For example, one or more applications 418 residing within storage device 406 may be configured to direct processor 404 to perform one or more processes or functions associated with communication facility 102, coupon management facility 104, coupon distribution facility 106, coupon reservation facility 108, and/or user interface facility 110. Likewise, data storage facility 112 may be implemented by or within storage device 406. For example, coupon content data 114, coupon metadata 116, and profile data 118 may be stored within storage device 406.

Exemplary processing, operations, tools, options, and/or user interfaces for managing, distributing, and reserving electronic coupons will now be described. One or more of the exemplary operations, tools, options, and/or user interfaces may be performed and/or provided by system 100, coupon subsystem 202, access device 204, 302, or 306, and/or device 400.

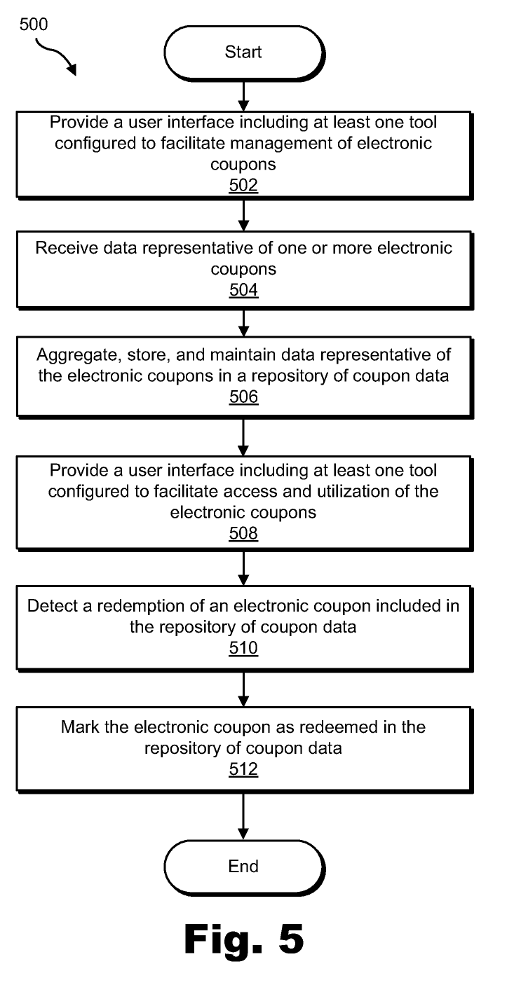

FIG. 5 illustrates an exemplary electronic coupon management and distribution method 500. While FIG. 5 illustrates exemplary steps according to one embodiment, other embodiments may omit, add to, reorder, and/or modify any of the steps shown in FIG. 5. One or more of the steps shown in FIG. 5 may be performed by system 100, coupon subsystem 202, access device 204, 302, or 306, and/or device 400.

In step 502, a user interface including at least one tool configured to facilitate management of electronic coupons is provided. The user interface may be provided in any form suitable to facilitate management of electronic coupons. For example, the user interface may include one or more GUIs having one or more tools configured to facilitate management of electronic coupons. In some examples, the user interface may be provided to a marketer to facilitate management of electronic coupons.

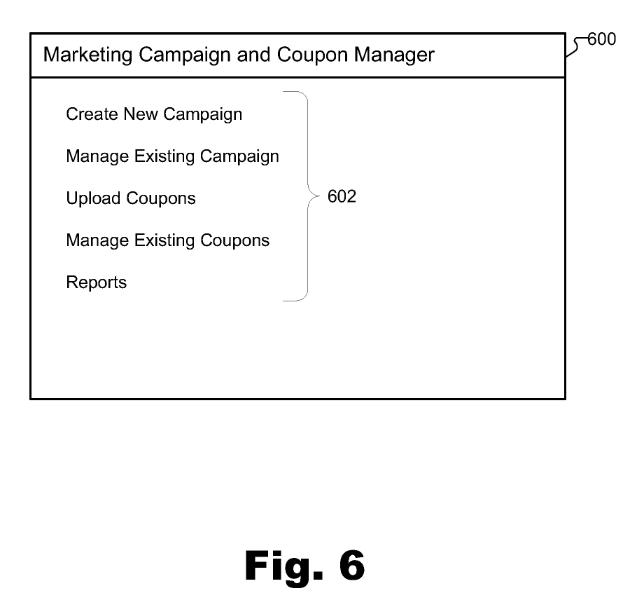

To illustrate, FIG. 6 shows an exemplary GUI 600 configured to facilitate management of electronic coupons. While FIG. 6 illustrates an exemplary GUI 600, the example is illustrative only. One or more additional and/or alternative GUIs configured to facilitate management of electronic coupons may be included in a user interface and provided to a marketer or other user.

GUI 600 may include one or more tools configured to facilitate management of electronic coupons. As shown in FIG. 6, GUI 600 may include a plurality of selectable management options 602. In the illustrated example, management options 602 include a “create new campaign” option, a “manage existing campaign” option, an “upload coupons” option, a “manage existing coupons” option, and a “reports” option. A marketer may select from the management options 602 to manage one or more marketing campaigns and/or electronic coupons. For example, through GUI 600, a marketer may create a new marketing campaign, manage an existing marketing campaign, upload one or more electronic coupons, manage existing electronic coupons, and access one or more reports associated with a marketing campaign and/or one or more electronic coupons.

As an example, a marketer may utilize GUI 600 and/or one or more other GUIs to create a new marketing campaign, upload one or more electronic coupons, and associate the electronic coupons with the marketing campaign. Returning to FIG. 5, in step 504, data representative of one or more electronic coupons may be received. For instance, data representative of one or more electronic coupons uploaded by the marketer may be received. In step 506, the received electronic coupons may be aggregated, stored, and maintained in a repository of coupon data in any of the ways described above.

The marketer may also utilize GUI 600 and/or one or more other GUIs to provide one or more settings for the marketing campaign and/or electronic coupons. For example, the marketer made provide input specifying a campaign expiration date, which in some examples may be used as an expiration date for each of the electronic coupons associated with the marketing campaign. Additionally or alternatively, the marketer may provide input specifying individual expiration dates for one or more electronic coupons. The marketer may also provide input specifying a reservation time period to be associated with a marketing campaign and/or one or more electronic coupons.

To illustrate, a marketer such as a retail food seller may create an advertising campaign that has an overall budget of one million dollars. The marketer may upload and associate one or more electronic coupons with the marketing campaign. For example, the marketer may provide input specifying that the marketing campaign includes two-hundred-thousand electronic coupons each having a value of five dollars. Accordingly, two-hundred-thousand electronic coupons each having a value of five dollars may be stored and maintained in a repository of coupon data for access by one or more consumers.

The marketer may also provide one or more expiration and/or reservation settings associated with the marketing campaign and/or electronic coupons. For instance, the marketer may provide input specifying that each of the coupons within the marketing campaign be assigned a particular expiration date three months from the creation of the marketing campaign. Each of the coupons may also be associated with a reservation time period selected by the marketer. For example, each electronic coupon associated with the marketing campaign may be assigned a two-week time period for which each of the coupons may be reserved, as described herein. Other settings may be similarly defined by the marketer, received by electronic coupon subsystem 202 from an access device associated with the marketer, and associated with a marketing campaign and/or one or more electronic coupons maintained in a repository of coupon data.

In addition, the marketer may utilize GUI 600 and/or one or more other GUIs to modify a marketing campaign, one or more electronic coupons, and campaign and/or coupon settings. As an example, the marketer may modify an expiration date and/or a reservation time period.

Returning again to FIG. 5, in step 508, a user interface including at least one tool configured to facilitate access and utilization of electronic coupons is provided. The user interface may be in any form suitable to facilitate access and utilization of electronic coupons. For example, the user interface may include one or more GUIs that may be provided to a consumer.

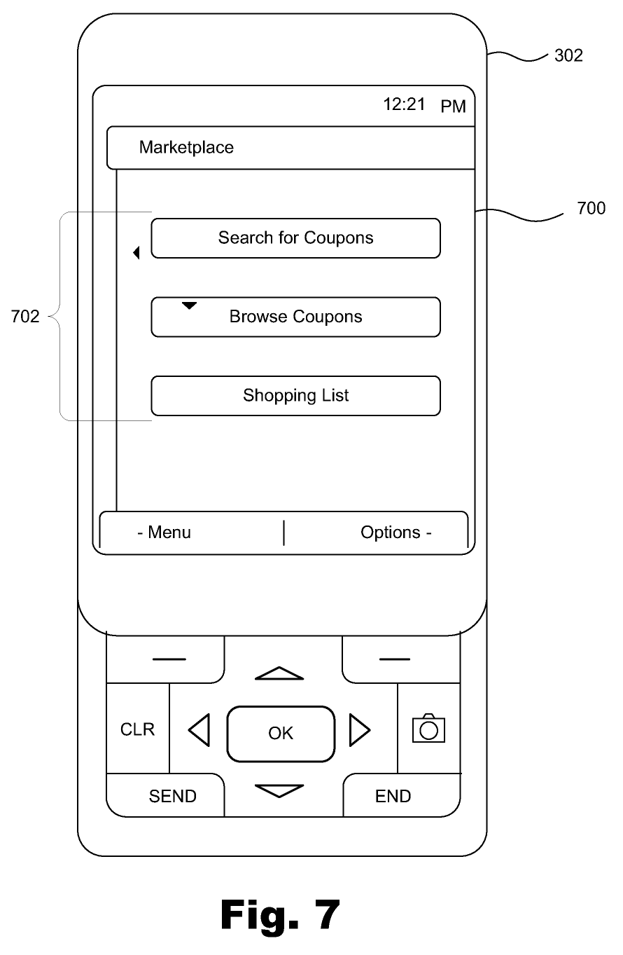

To illustrate, FIGS. 7-9 illustrate exemplary GUIs that may be provided to a consumer. FIG. 7 illustrates an access device 302 having an exemplary GUI 700 displayed thereon. As shown in FIG. 7, GUI 700 may include a plurality of selectable options 702 configured to facilitate access and utilization of electronic coupons maintained in a repository of coupon data. In the illustrated example, options 702 include a “search for coupons” option, a “browse coupons” option, and a “shopping list” option. By utilizing one or more of the options 702, a consumer may search for coupons within a repository of coupon data by keyword, category (e.g., grocery, restaurant, electronics, home furnishings, apparel, etc.), brand, retailer, manufacturer, product, service, distributor, source, and/or any other criterion. Also add description of shopping list here.

As mentioned above, one or more of the electronic coupon management, distribution, and/or reservation systems and/or methods described herein may be integrated with a shopping list and/or recipe application or service. For example, options 702 include a “shopping list” option that may be selected to access an application and/or service for maintaining a shopping list on or through access device 302. Electronic coupons may be integrated with a shopping list in a variety of ways, such as by providing capabilities to search for coupons related to items included in a shopping list, providing links between shopping list items and relevant electronic coupons, etc.

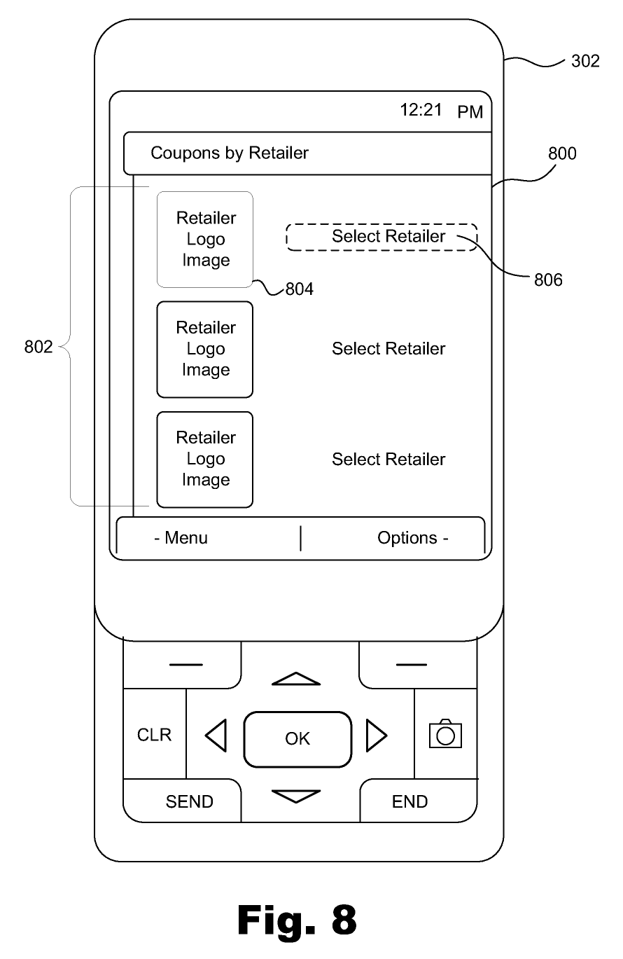

As an example of searching for electronic coupons within a repository of coupon data, a consumer may utilize GUI 700 and/or one or more other GUIs to search for electronic coupons by retailer. FIG. 8 illustrates an exemplary GUI 800 displayed by access device 302. GUI 800 may be displayed in response to a consumer choosing to browse for electronic coupons by retailer in GUI 700. As shown in FIG. 8, a list of retailers 802 is displayed in GUI 800. Each retailer is represented by a retailer logo image in GUI 800. Next to each retailer logo image, a selectable option for selecting the retailer is displayed. For example, next to the first retailer logo image 804 displayed in GUI 800, a selectable option 806 for selecting the first retailer is displayed. When a consumer selects one of the options (e.g., option 806), another GUI may be displayed. To illustrate, a consumer may select the “Select Retailer” option 806 displayed in GUI 800. In response, another GUI may be displayed and may include additional information associated with the selected retailer. For example, a GUI including a list of one or more electronic coupons associated with the selected retailer may be displayed. From this list, a consumer may select one or more of the electronic coupons.

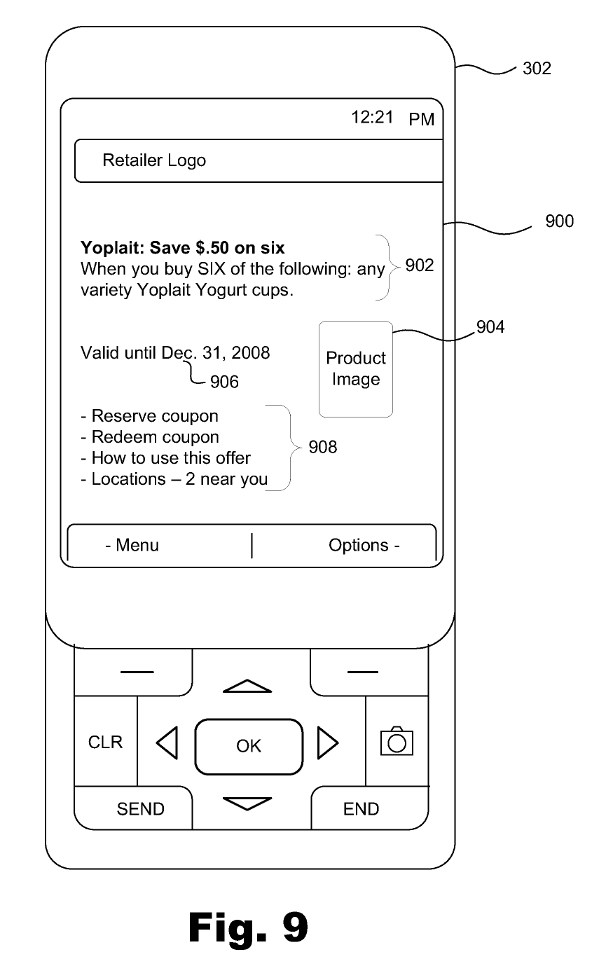

FIG. 9 illustrates an exemplary GUI 900 displayed by access device 302. GUI 900 may be displayed in response to a selection of an electronic coupon from a list of electronic coupons, such as a selection of an electronic coupon from the above-described list of electronic coupons associated with a selected retailer. As shown in FIG. 9, GUI 900 may include additional information 902 about the electronic coupon. GUI 900 may also include an image 904 of a product associated with the coupon and an expiration date 906 associated with the electronic coupon. In addition, GUI 900 may include a plurality of selectable options 908 associated with electronic coupon. In FIG. 9, options 908 include a “reserve coupon” option, a “redeem coupon” option, a “how to use this offer” option, and a “locations” option. Accordingly, a consumer may select from options 908 to reserve the electronic coupon, redeem the electronic coupon, access additional information about using the electronic coupon, and access information about locations where the coupon may be used.

As an example, a consumer may choose to redeem the electronic coupon represented in GUI 900. The redemption may be accomplished in any suitable way. For example, the electronic coupon may be redeemed by applying it to a purchase of the corresponding product, such as by applying the electronic coupon to a consumer or retailer loyalty, savings, value, credit, or processing card or account, crediting a value of the electronic coupon against a purchase of the product, showing the displayed electronic coupon to a retailer when making a purchase of the product, a retailer scanning information displayed on access device 302 to receive the electronic coupon, and any other suitable way for redeeming the coupon and applying it to a purchase of the corresponding product or service. When the electronic coupon is redeemed, access device 302 may transmit a redemption message to electronic coupon subsystem 202 signaling the redemption of the electronic coupon.

Returning again to FIG. 5, in step 510, a redemption of an electronic coupon included in the repository of coupon data is detected. The detection may be performed in any suitable way. For example, electronic coupon subsystem 202 may receive a redemption message from an access device 208 or 302 signaling a redemption of the electronic coupon. Electronic coupon subsystem 202 may be configured to perform one or more operations in response to the detected redemption of the electronic coupon. The operations may include any operations potentially helpful for redeeming and reconciling and electronic coupon. For example, in step 512, the electronic coupon may be marked as redeemed in the repository of coupon data. This may include setting a status of the electronic coupon to “redeemed.” This status may indicate that the electronic coupon is no longer available. In addition, electronic coupon subsystem 202 may record the redemption for use in one or more reports and/or communicate with a source of the electronic coupon for redemption and/or reconciliation purposes.

As mentioned, electronic coupons maintained in a repository of coupon data may be tracked and one or more predefined actions performed in response to one or more predetermined tracking events. In certain embodiments, the predetermined tracking events may include, without limitation, changes in the statuses of electronic coupons, events that trigger changes in the statuses of electronic coupons, expiration of dates associated with electronic coupons, and approaching expiration of dates associated with electronic coupons. Examples of reservations of electronic coupons, as well as tracking events and predefined actions associated with reservations of electronic coupons will now be described in further detail.

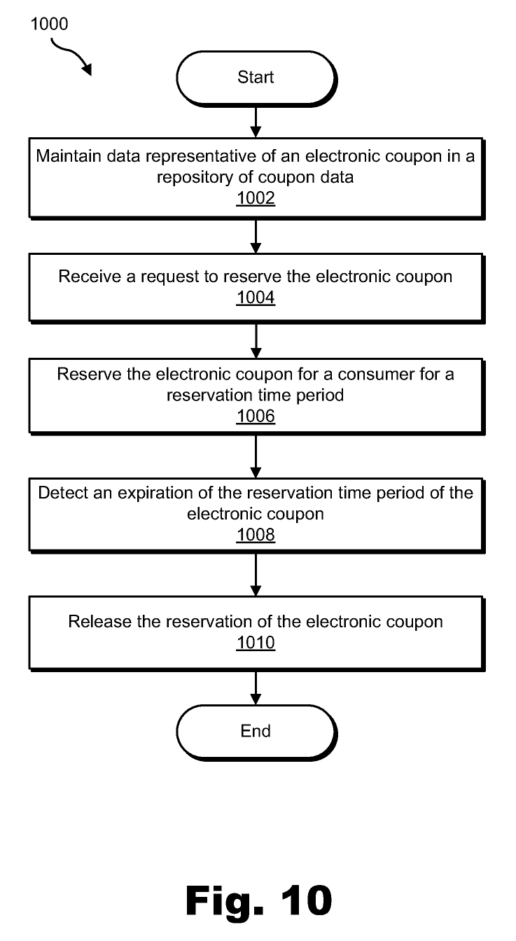

FIG. 10 illustrates an exemplary electronic coupon reservation method 1000. While FIG. 10 illustrates exemplary steps according to one embodiment, other embodiments may omit, add to, reorder, and/or modify any of the steps shown in FIG. 10. One or more of the steps shown in FIG. 10 may be performed by system 100, coupon subsystem 202, access device 204, 302, or 306, and/or device 400.

In step 1002, data representative of an electronic coupon is maintained in a repository of coupon data. Step 1002 may be performed in any of the ways described above. For example, coupon subsystem 202 may maintain data representative of the electronic coupon in a repository of coupon data such that the electronic coupon is accessible to a plurality of access devices (e.g., access devices 204 and/or 302) associated with a plurality of consumers.

In step 1004, a request to reserve the electronic coupon is received. For example, electronic coupon subsystem 202 may receive a request to reserve the electronic coupon from an access device (e.g., access device 204 or 302) associated with a consumer.

In step 1006, the electronic coupon is reserved for a consumer for a reservation time period. For example, coupon subsystem 202 may perform one or more operations to reserve the electronic coupon for the consumer for the reservation time period. The reservation may be performed in a manner such that the electronic coupon is made unavailable to one or more other consumers during the reservation time period.

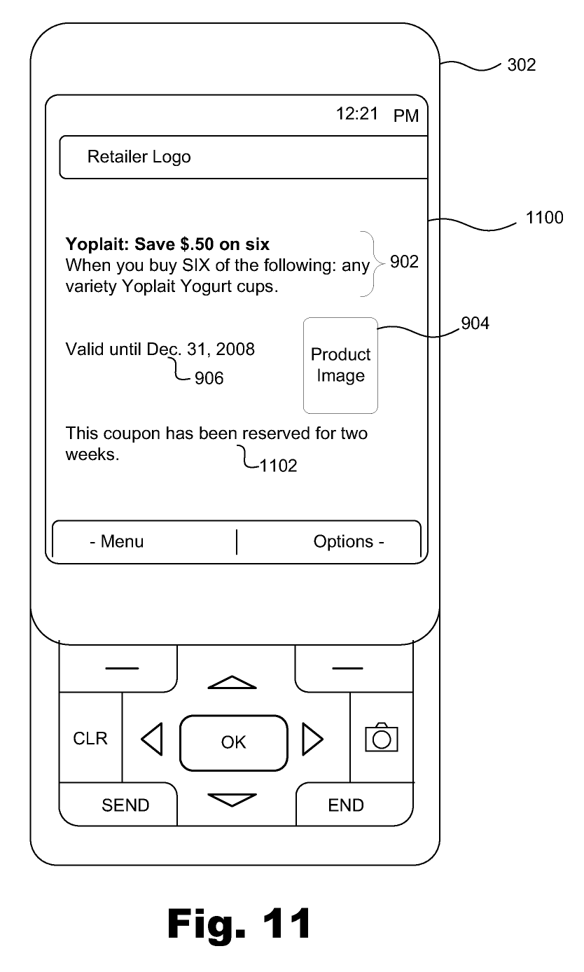

Step 1006 may include marking the electronic coupon (e.g., a status of the electronic coupon) as reserved for the reservation time period in the repository of coupon data in response to the request received in step 1004. In some examples, step 1006 may also include transmitting data representative of the electronic coupon to the requesting access device associated with the consumer in response to the request received in step 1004. In some examples, step 1006 may also include notifying the consumer of the reservation and/or the reservation time period. To illustrate, FIG. 11 shows an exemplary GUI 1100 displayed by an access device 302. As shown in FIG. 11, GUI 1100 may include a notification message 1102 displayed therein and indicating that the electronic coupon has been reserved for a two-week reservation time period.

Returning to FIG. 10, in step 1008, an expiration of the reservation time period of the electronic coupon is detected. The detection may be performed in any suitable way, including by tracking an actual time against the reservation time period to determine when the actual time reaches the expiration of the reservation time period.

In step 1010, the reservation of the electronic coupon is released. For example, coupon subsystem 202 may release the reservation of the electronic coupon in response to the expiration of the reservation time period detected in step 1008. In certain embodiments, the release of the reservation of the electronic coupon may include coupon subsystem 202 marking the electronic coupon as available in the repository of coupon data in response to the detected expiration of the reservation time period. The release may also include invalidating data representative of the electronic coupon and/or the reservation of the electronic coupon as may be maintained by an access device associated with the consumer in response to the expiration of the reservation time period. In some embodiments, the invalidating may cause the consumer to be unable to redeem the coupon after the reservation is released.

By releasing the reservation of the electronic coupon in response to the detected expiration of the reservation time period of the electronic coupon, and effectiveness of the electronic coupon may be increased as compared to convention coupon distribution techniques. For example, if the consumer forgets about the reservation of the electronic coupon and/or fails to redeem the reserved electronic coupon within the reservation time period, the electronic coupon may be made available again for access and use by one or more consumers. Accordingly, an increased chance of redemption of the electronic coupon may be facilitated.

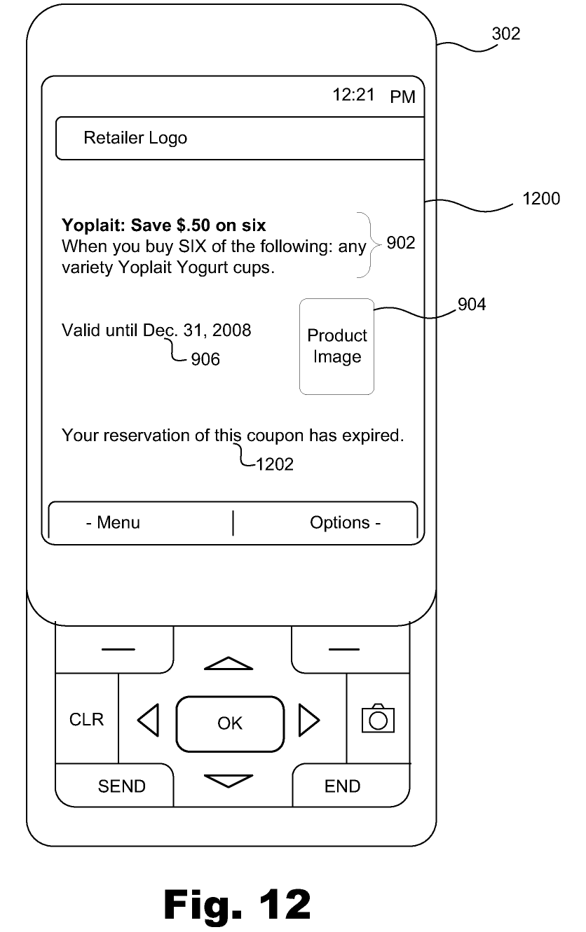

In some examples, the release of the reservation of the electronic coupon in step 1010 may include notifying the consumer of the release of the reservation. To illustrate, FIG. 12 shows an exemplary GUI 1200 displayed by an access device 302. As shown in FIG. 12, GUI 1200 may include a notification message 1202 displayed therein and indicating that the reservation of the electronic coupon has expired and/or been released.

One or more of the steps shown in FIG. 10 may be repeated. For example, steps 1004 and 1006 may be repeated to receive another request to reserve the electronic coupon from another access device associated with another consumer and reserve the electronic coupon for the other consumer in response to the request.

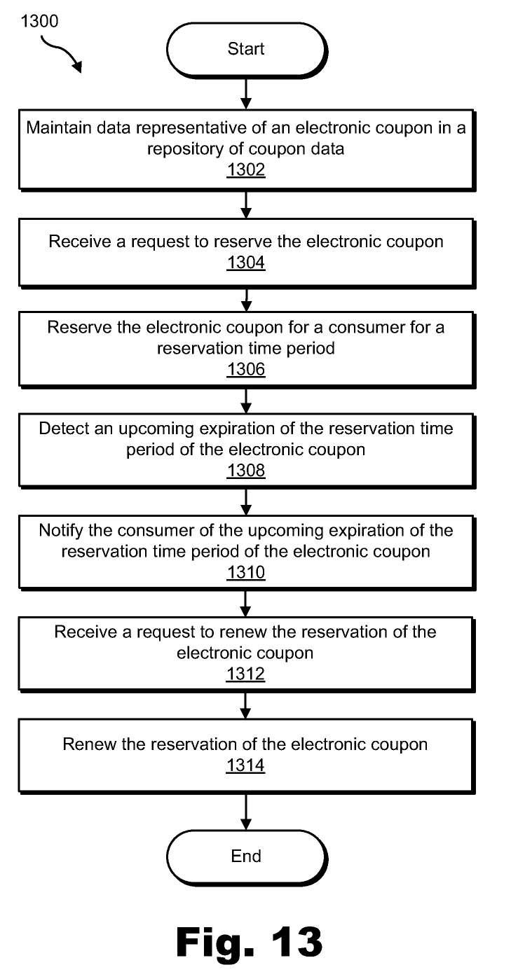

FIG. 13 illustrates another exemplary electronic coupon reservation method 1300. While FIG. 13 illustrates exemplary steps according to one embodiment, other embodiments may omit, add to, reorder, and/or modify any of the steps shown in FIG. 13. One or more of the steps shown in FIG. 13 may be performed by system 100, coupon subsystem 202, access device 204, 302, or 306, and/or device 400.

In steps 1302, 1304, and 1306, data representative of an electronic coupon is maintained in a repository of coupon data, a request to reserve the electronic coupon is received, and the electronic coupon is reserved for a consumer for a reservation time period. Steps 1302, 1304, and 1306 may be performed in any of the ways described above in reference to steps 1002,1004, and 1006 of FIG. 10.

In step 1308, an upcoming expiration of the reservation time period of the electronic coupon is detected. The detection may be performed in any suitable way. For example, when a tracked actual time is within a predetermined time range of the ending time of the reservation time period, the upcoming expiration of the reservation may be detected.

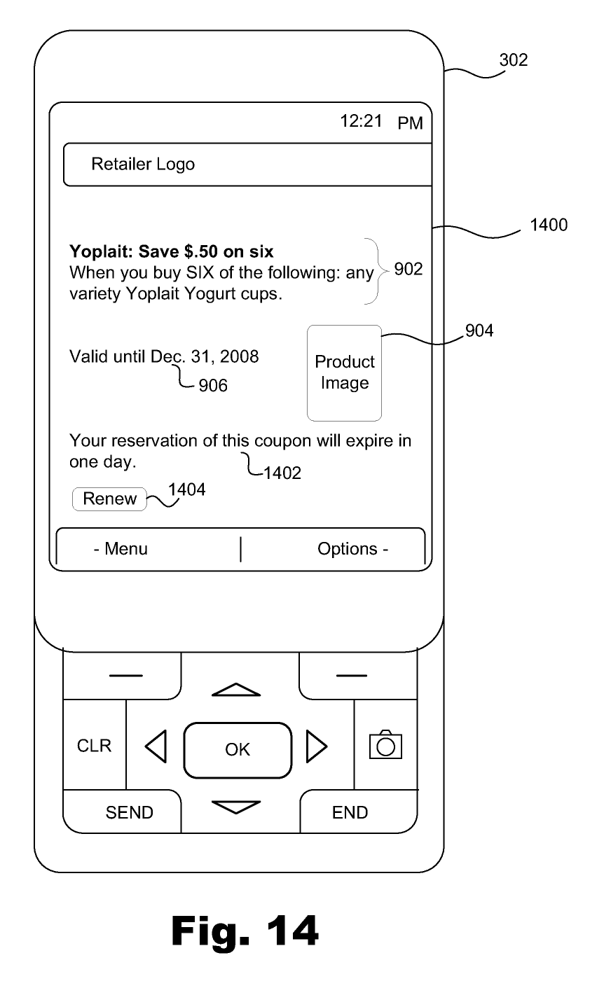

In step 1310, the consumer is notified of the upcoming expiration of the reservation time period of the electronic coupon. For example, coupon subsystem 202 may transmit a notification of the upcoming expiration to an access device associated with the consumer. To illustrate, FIG. 14 shows an exemplary GUI 1400 displayed by an access device 302. As shown in FIG. 14, GUI 1400 may include a notification 1402 displayed therein and indicating the upcoming expiration of the reservation time period.

In certain embodiments, at least one tool configured to facilitate a renewal of the reservation of the electronic coupon may be provided to the consumer. For example, GUI 1400 may include a reservation renewal option 1404. The consumer may select and/or utilize the reservation renewal tool 1404 to indicate a desire to renew the reservation of the electronic coupon. In response to a selection of option 1404, a renewal of the reservation may be initiated, such as by an access device transmitting data representative of a renewal request to coupon subsystem 202.

Returning to FIG. 13, in step 1312, a request to renew the reservation of the electronic coupon is received. For example, coupon subsystem 202 may receive the request to renew the reservation of the electronic coupon from an access device associated with the consumer.

In step 1314, the reservation of the electronic coupon is renewed. For example, the reservation of the electronic coupon may be renewed in the repository of coupon data such as by extending the reservation time period and/or setting a new reservation time period for the reservation.

By notifying the consumer of an upcoming expiration of the reservation of the electronic coupon and/or providing at least one tool configured to facilitate renewal of the reservation of electronic coupon, one or more efficiencies may be provided. For example, the chances of the electronic coupon being redeemed may be increased. For instance, if the consumer forgets about the reservation of the electronic coupon and/or fails to redeem the electronic coupon before the expiration of the reservation time period, the consumer may be notified and given an opportunity to renew and/or redeem the electronic coupon before the expiration of the reservation of electronic coupon.

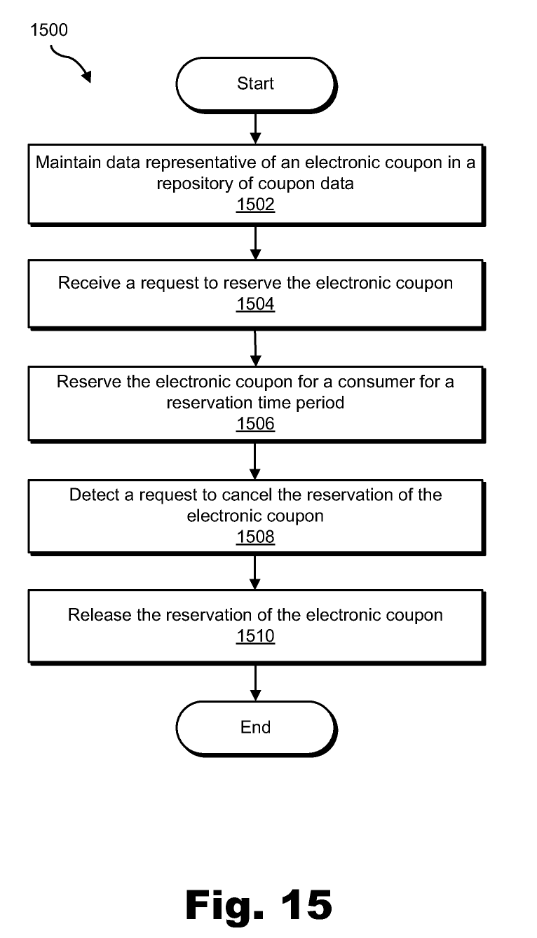

FIG. 15 illustrates another exemplary electronic coupon reservation method 1500. While FIG. 15 illustrates exemplary steps according to one embodiment, other embodiments may omit, add to, reorder, and/or modify any of the steps shown in FIG. 15. One or more of the steps shown in FIG. 15 may be performed by system 100, coupon subsystem 202, access device 204, 302, or 306, and/or device 400.

In steps 1502, 1504, and 1506, data representative of an electronic coupon is maintained in a repository of coupon data, a request to reserve the electronic coupon is received, and the electronic coupon is reserved for a consumer for a reservation time period. Steps 1502, 1504, and 1506, may be performed in any of the ways described above in reference to steps 1002, 1004, and 1006 of FIG. 10.

In step 1508, a request to cancel the reservation of electronic coupon is detected. The detection may be performed in any suitable way. For example, coupon subsystem 202 may receive a cancellation request from an access device associated with the consumer. The cancellation request may be generated and transmitted by the access device in response to the consumer selecting a reservation cancellation tool or option, which may be provided in a GUI, for example.

In step 1510, the reservation of the electronic coupon is released. The release of the reservation, which may be performed in any of the ways described above, may be performed in response to the cancellation request received in step 1608.

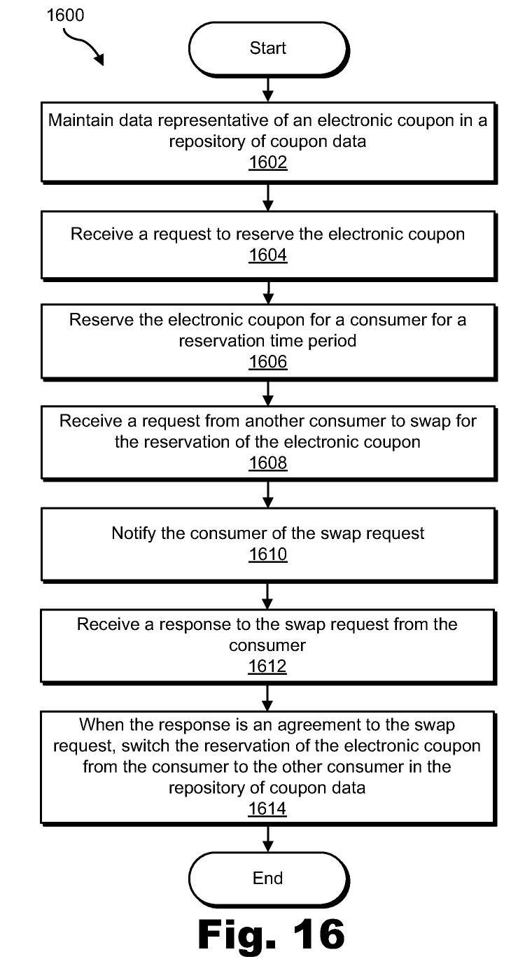

FIG. 16 illustrates another exemplary electronic coupon reservation method 1600. While FIG. 16 illustrates exemplary steps according to one embodiment, other embodiments may omit, add to, reorder, and/or modify any of the steps shown in FIG. 16. One or more of the steps shown in FIG. 16 may be performed by system 100, coupon subsystem 202, access device 204, 302, or 306, and/or device 400.

In steps 1602, 1604, and 1606, data representative of an electronic coupon is maintained in a repository of coupon data, a request to reserve the electronic coupon is received, and the electronic coupon is reserved for a consumer for a reservation time period. Steps 1602, 1604, and 1606, may be performed in any of the ways described above in reference to steps 1002, 1004, and 1006 of FIG. 10.

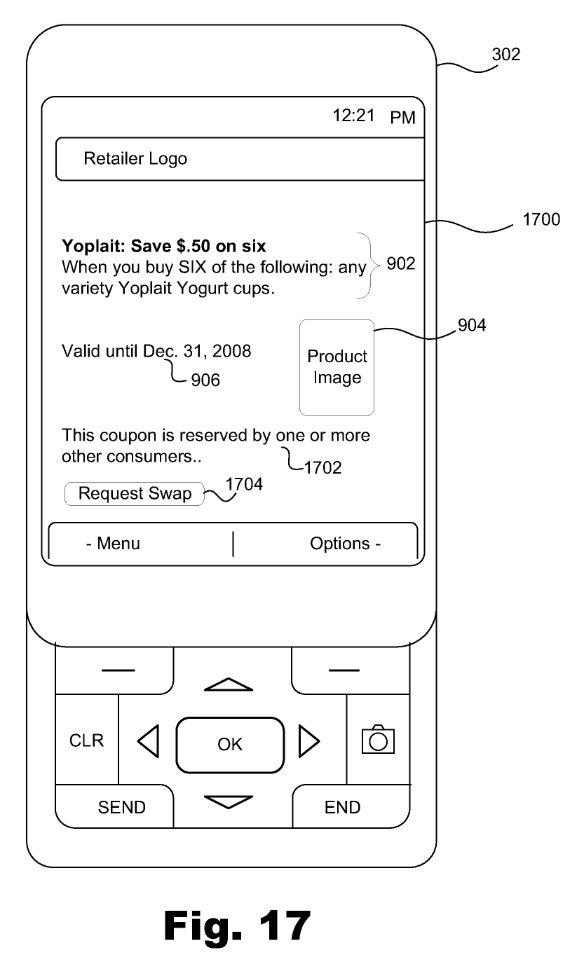

In step 1608, a request is received from another consumer to swap for the reservation of the electronic coupon. For example, coupon subsystem 202 may receive the swap request from an access device associated with the other consumer. As an example, the other consumer may attempt to access and reserve or redeem the electronic coupon only to discover that the electronic coupon is reserved to the first consumer. Accordingly, the electronic coupon may be unavailable to the other consumer. If the other consumer wishes to gain access to the electronic coupon, the other consumer may initiate the swap request. For example, the other consumer may be able to utilize a user interface tool and/or option to initiate a swap request for the electronic coupon. To illustrate, FIG. 17 shows an exemplary GUI 1700 displayed by an access device 302. As shown in FIG. 17, GUI 1700 may include a notification 1702 displayed therein and indicating that the electronic coupon is currently unavailable and/or reserved to one or more other consumers. GUI 1700 may also include a reservation swap tool 1704 that may be selected by the other consumer to initiate a request to swap for the reservation of the electronic coupon.

The swap request may be generated and transmitted from the access device associated with the other consumer to coupon subsystem 202. The swap request may include any information related to a request to swap a reservation of an electronic coupon. For example, the swap request may include data representative of any consideration offered by the other consumer in exchange for the reservation of the electronic coupon. Such consideration may include anything of value, including, without limitation, one or more reservations of electronic coupons owned by the other consumer and monetary compensation. Accordingly, system 100 may support swapping and requests for swapping reservations of electronic coupons between consumers.

Returning to FIG. 16, in step 1610, the consumer is notified of the swap request. The notification may be performed in any suitable way. For example, coupon subsystem 202 may transmit a swap request notification message to an access device associated with the consumer. In some examples, a swap request notification message may be transmitted to an access device associated with each consumer who has reserved an electronic coupon identical and/or similar to the electronic coupon reserved to which the swap request is targeted.

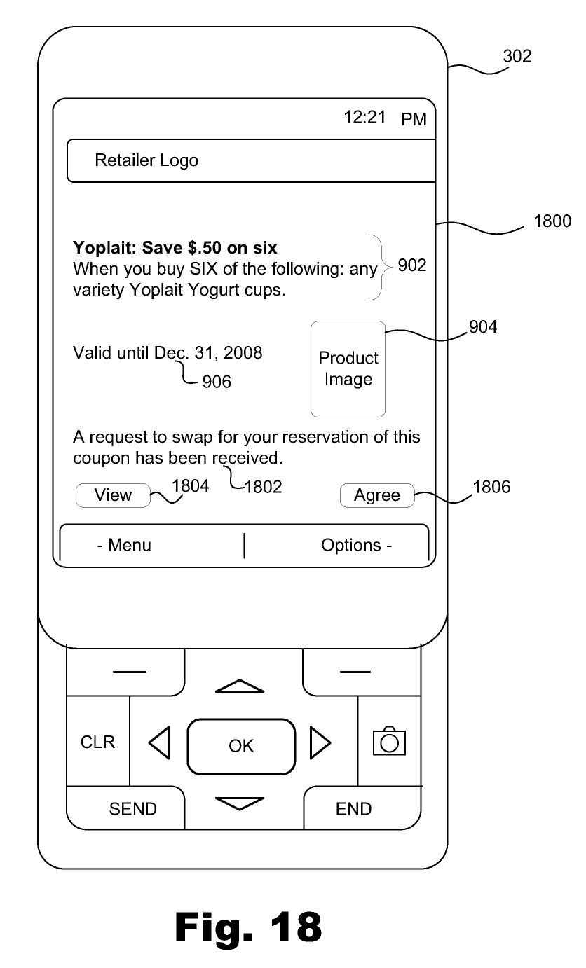

FIG. 18 illustrates an exemplary GUI 1800 displayed by an access device 302. As shown in FIG. 18, GUI 1800 may include a notification 1802 of the swap request displayed therein. In addition, GUI 1800 may include an option 1804 to view the swap request and/or additional details of the swap request (e.g., information about the requesting consumer, consideration offered by the requesting consumer, etc.) and an option 1806 to agree to or reject the swap request.

Returning again to FIG. 16, in step 1612, a response to the swap request is received from the consumer. For example, the consumer may provide input through GUI 1800 to indicate a response to the swap request. The access device associated with the consumer may transmit data representative of the response to coupon subsystem 202, which may receive the data representative of the response to the swap request in step 1612.

Coupon subsystem 202 may be configured to perform one or more operations based on the response received in step 1612. For example, when the response is a rejection of the swap request, coupon subsystem 202 may notify the other consumer of the rejection. When the response is an agreement to the swap request, the reservation of the electronic coupon may be switched from the consumer to the other consumer in the repository of coupon data. This switch may be performed in step 1614 of FIG. 16. In some examples, step 1614 may include notifying the consumer and/or the other consumer of the switch of the reservation of the electronic coupon.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
maintaining, by an electronic coupon subsystem, data representative of an electronic coupon in a repository of coupon data such that the electronic coupon is accessible to a plurality of access devices associated with a plurality of consumers;
receiving, by the electronic coupon subsystem, a request to reserve the electronic coupon from an access device within the plurality of access devices, the access device associated with a consumer within the plurality of consumers; and
reserving, by the electronic coupon subsystem, the electronic coupon for the consumer for a reservation time period such that the electronic coupon is unavailable to one or more other consumers within the plurality of consumers during the reservation time period.

2. The method of claim 1, wherein the reserving comprises:
marking the electronic coupon as reserved for the reservation time period in the repository of coupon data in response to the request; and
transmitting data representative of the electronic coupon to the access device associated with the consumer in response to the request.

3. The method of claim 1, further comprising:
detecting, by the electronic coupon subsystem, an expiration of the reservation time period of the electronic coupon; and
releasing, by the electronic coupon subsystem, the reservation of the electronic coupon in response to the expiration of the reservation time period.

4. The method of claim 3, wherein the releasing comprises:
marking the electronic coupon as available in the repository of coupon data in response to the expiration of the reservation time period; and
invalidating data representative of the electronic coupon on the access device associated with the consumer in response to the expiration of the reservation time period.

5. The method of claim 3, further comprising:
receiving, by the electronic coupon subsystem, another request to reserve the electronic coupon from another access device within the plurality of access devices, the another access device associated with another consumer within the plurality of consumers; and
reserving, by the electronic coupon subsystem, the electronic coupon for the another consumer for another reservation time period such that the electronic coupon is unavailable to one or more other consumers within the plurality of consumers for the another reservation time period.

6. The method of claim 1, further comprising:
receiving, by the electronic coupon subsystem, data representative of the electronic coupon from an access device associated with a marketer; and
storing, by the electronic coupon subsystem, data representative of the electronic coupon in the repository of coupon data.

7. The method of claim 1, further comprising:
detecting, by the electronic coupon subsystem, an upcoming expiration of the reservation time period of the electronic coupon; and
transmitting, by the electronic coupon subsystem, a notification of the upcoming expiration to the access device associated with the consumer.

8. The method of claim 7, further comprising:
receiving, by the electronic coupon subsystem, a request to renew the reservation of the electronic coupon; and
renewing, by the electronic coupon subsystem, the reservation of the electronic coupon in response to the renewal request.

9. The method of claim 1, further comprising:
receiving, by the electronic coupon subsystem, a request to cancel the reservation of the electronic coupon; and
releasing, by the electronic coupon subsystem, the reservation of the electronic coupon in response to the cancellation request.

10. The method of claim 1, further comprising:
receiving, by the electronic coupon subsystem, a redemption message from the access device associated with the consumer; and
marking, by the electronic coupon subsystem, the electronic coupon as redeemed in the repository of coupon data in response to the redemption message.

11. The method of claim 1, further comprising:
receiving, by the electronic coupon subsystem, a swap request from another access device within the plurality of access devices, the another access device associated with another consumer within the plurality of consumers, the swap request comprising data representative of a request to swap for the reservation of the electronic coupon; and
transmitting, by the electronic coupon subsystem, a notification of the swap request to the access device associated with the consumer for whom the electronic coupon is reserved.

12. The method of claim 11, further comprising:
receiving, by the electronic coupon subsystem, an agreement to the swap request from the access device associated with the consumer; and
switching, by the electronic coupon subsystem, the reservation of the electronic coupon from the consumer to the another consumer in the repository of coupon data in response to the agreement.

13. The method of claim 1, tangibly embodied as computer-executable instructions on at least one computer-readable medium.

14. A method comprising:
receiving, by an electronic coupon subsystem, data representative of an electronic coupon from an access device associated with a marketer, the data representative of the electronic coupon including a reservation setting for the electronic coupon;
maintaining, by the electronic coupon subsystem, data representative of the electronic coupon in a repository of coupon data;
marking a status of the electronic coupon maintained in the repository of coupon data as available such that the electronic coupon is accessible to a plurality of access devices associated with a plurality of consumers;
receiving, by the electronic coupon subsystem, a request to reserve the electronic coupon from an access device within the plurality of access devices associated with the plurality of consumers, the access device associated with a consumer within the plurality of consumers; and
marking, by the electronic coupon subsystem, the status of the electronic coupon as reserved for the consumer for a reservation time period based on the reservation setting such that the electronic coupon is unavailable to one or more other consumers within the plurality of consumers during the reservation time period.

15. The method of claim 14, further comprising:
receiving, by the electronic coupon subsystem, a redemption message from the access device associated with the consumer; and
marking, by the electronic coupon subsystem, the status of the electronic coupon as redeemed in the repository of coupon data in response to the redemption message.

16. A system comprising:
a coupon management facility that maintains data representative of an electronic coupon in a repository of coupon data within a data storage facility;
a coupon distribution facility configured to distribute the electronic coupon to a plurality of access devices associated with a plurality of consumers; and
a coupon reservation facility that
receives a request to reserve the electronic coupon from an access device within the plurality of access devices, the access device associated with a consumer within the plurality of consumers, and
reserves the electronic coupon for the consumer for a reservation time period such that the electronic coupon is unavailable to one or more other consumers within the plurality of consumers during the reservation time period.

17. The system of claim 16, wherein the coupon reservation facility detects an expiration of the reservation time period of the electronic coupon and releases the reservation of the electronic coupon in response to the expiration of the reservation time period.

18. The system of claim 16, wherein the coupon reservation facility
detects an upcoming expiration of the reservation time period of the electronic coupon,
transmits a notification of the upcoming expiration to the access device associated with the consumer,
receives a request to renew the reservation of the electronic coupon, and
renews the reservation of the electronic coupon in response to the renewal request.

19. The system of claim 18, further comprising a user interface facility that provides a graphical user interface including at least one tool configured to facilitate initiation of at least one of the request to reserve the electronic coupon and the request to renew the reservation of the electronic coupon.

20. The system of claim 16, wherein the coupon management facility
receives data representative of the electronic coupon from an access device associated with a marketer, the data representative of the electronic coupon including a reservation setting and an expiration setting for the electronic coupon, and
stores data representative of the electronic coupon in the repository of coupon data.

21. The system of claim 20, further comprising a user interface facility that provides a graphical user interface including at least one tool configured to facilitate management of at least one of a marketing campaign and the electronic coupon by the marketer.

22. The system of claim 16, wherein the plurality of access devices associated with the plurality of consumers comprises one or more mobile phone devices.
